(19) United States
(12) Patent Application Publication
(10) Pub. No.: US 2014/0012830 A1
(43) Pub. Date: Jan. 9, 2014

(54) DATA VERIFICATION SYSTEM

(71) Applicants: Pascal Hochwarth, Sandhausen (DE); Tanja Soehngen, Neulussheim (DE); Christian Boehrer, Hoepfingen (DE); Benjamin Klehr, Kuppenheim (DE); Paola Sala, Heidelberg (DE); Elena Gurevitch, Bad Schoenborn (DE)

(72) Inventors: Pascal Hochwarth, Sandhausen (DE); Tanja Soehngen, Neulussheim (DE); Christian Boehrer, Hoepfingen (DE); Benjamin Klehr, Kuppenheim (DE); Paola Sala, Heidelberg (DE); Elena Gurevitch, Bad Schoenborn (DE)

(73) Assignee: SAP AG, Walldorf (DE)

(21) Appl. No.: 13/544,356

(22) Filed: Jul. 9, 2012

(51) Int. Cl. G06F 17/30

(52) U.S. Cl. 707/701; 707/E17.007

(57) ABSTRACT

Embodiments of the present invention may provide a system for asynchronous data verification processing. The processing may include receiving input data for verification. The processing may parse the input data into synchronous and asynchronous data verification tasks. The synchronous data verification tasks may include linking the input data to information stored in the system. The synchronous data verification tasks may further include checking the input data for typographical errors. The asynchronous data verification tasks may include comparing the input data to the linked system data, determining one or more differences between the input data and the linked system data that may be present, and reporting the differences to a user of the system.

### BACKGROUND

Typically, systems that perform data verification operate in a synchronous manner, requiring synchronous verification for data input to the system. The synchronous data verification limits data entry into the system to serial data input methods. For example, a user submitting invoices to an enterprise resource planning program must input data for a first invoice and wait for synchronous verification of the data before proceeding to input data for a second invoice. Thus, synchronous data verification increases data entry time.

Synchronous data verification is also resource intensive, consuming resources such as memory and system processing capabilities during synchronous data verification processing. Synchronous data verification is performed in an “online” manner, which limits a user's ability to perform other system tasks in parallel with the verification of data. This further increases data entry time, limits the amount of data that may be input into the system, and limits usage of the system for other tasks during the synchronous data verification. Accordingly, there is a need in the art to improve data verification processing for enterprise software systems.

### BRIEF DESCRIPTION OF THE DRAWINGS

FIG. 1 illustrates a block diagram of a system to provide for asynchronous data verification according to an embodiment of the present invention.

FIG. 2 illustrates a flow diagram of a method to provide for asynchronous data verification according to an embodiment of the present invention.

FIG. 3 illustrates a hardware configuration for implementing an asynchronous data verification system according to an embodiment of the present invention.

### DETAILED DESCRIPTION

Embodiments of the present invention may provide a system for asynchronous data verification processing. The processing may include receiving input data for verification. The processing may parse the input data into synchronous and asynchronous data verification tasks. The synchronous data verification tasks may include linking the input data to information stored in the system. The synchronous data verification tasks may further include checking the input data for typographical errors. The asynchronous data verification tasks may include comparing the input data to the linked system data, determining one or more differences between the input data and the linked system data that may be present, and reporting the differences to a user of the system.

An enterprise resource planning (“ERP”) system may be configured to provide for asynchronous data verification. Multiple applications may be provided in an ERP system to enable a business organization or enterprise to perform various business related tasks. The ERP system may store or manage data used or manipulated by the applications. For example, one ERP application may include an invoice reporting application. The invoice reporting application may track workflow tasks for a business organization.

For example, a first business organization may generate a purchase order for certain work, materials, goods, etc. to be provided or performed by another second business organization. The purchase order and data or information contained therein may be stored in the ERP system. Upon completion of the work or delivery of the materials, goods, etc. the second business organization may remit an invoice to the first business organization for payment. The second business organization may include additional information with the invoice including an accounting of the work product (e.g., work performed or materials, goods, etc. provided to the first business organization). The invoice and accounting information may be input to the invoice reporting system. In various embodiments, a user may input the information to the invoice reporting system manually, or the information may be provided to the first business organization in electronic form, thereby enabling the information to be loaded into the system in a batch processing manner (i.e., multiple invoices and corresponding accounting information may be loaded into the system as a batch of information).

The invoice reporting system may parse the entered information into synchronous and asynchronous data verification tasks. The synchronous verification tasks may be performed “online” as the information may be entered. Synchronous verification tasks may include checking the entered information for typographical errors and/or alerting a user of such errors. Synchronous verification tasks may also include verifying and linking the entered information with purchase orders or other information already present in the system.

Asynchronous data verification tasks may include verifying the linked information between purchase orders information, invoice information, and work product information (i.e., time sheet information for work performed or billed, bills of materials, etc.). The asynchronous data verification tasks may be performed using “offline” or “background” processing resources separate from synchronous data verification resources. Such offline processing may provide for additional invoice information to be entered into the invoice reporting system or may allow a user to operate other applications within the ERP system. In this manner, the user's productivity for performing other tasks is decoupled from the time required by the invoice reporting system to perform asynchronous data verification tasks. In aggregate, productivity for a business organization as a whole may be improved by providing various systems that may be adapted to perform asynchronous data verification tasks.

Upon completion of the asynchronous data verification tasks in the invoice reporting system, a report may be communicated to the user indicating results of the data verification. In an embodiment, the report may identify inconsistencies between the purchase order information, the invoice information, and the work product information. Following completion of the asynchronous data verification tasks, the invoice reporting system may post the invoice.

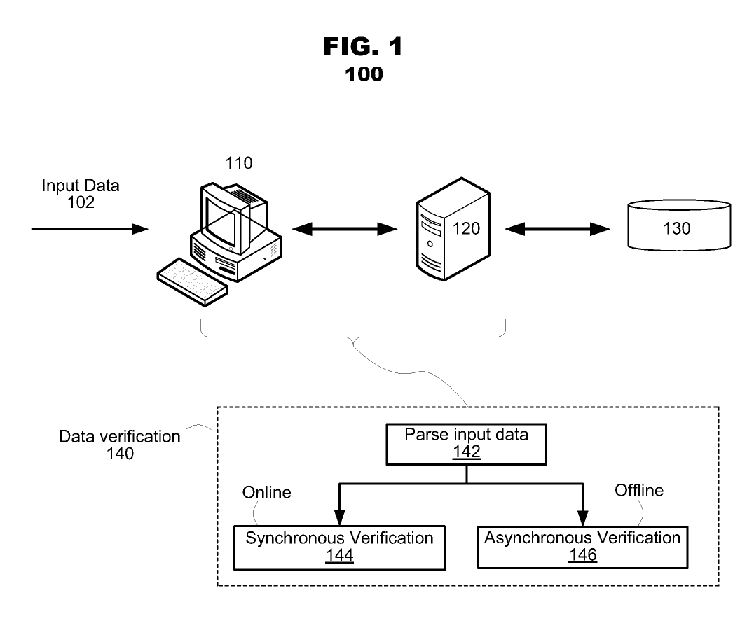

FIG. 1 illustrates a block diagram of a system 100 to provide for asynchronous data verification according to an embodiment of the present invention. As illustrated in FIG. 1, the system may include a client terminal 110, a networked server 120, and a data storage device 130. The client terminal 110 may receive input data 102 for verification processing. Following data input, the system 100 may perform various data verification tasks 140. In various embodiments, the data verification tasks may be performed by the client terminal 110 and the networked server 120 according to a verification task type which may be performed by the system 100.

The data verification tasks 140 may include input data parsing 142, which may segment the input data 102 according to a verification task type—synchronous verification 144 and asynchronous verification 146—to be performed. The synchronous verification 144 may be performed in an online manner, which may include linking the input data 102 to data previously stored in the system. The previously stored data may be maintained in any of the client terminal 110, the networked server 120, or the data storage device 130.

In an embodiment, the linking may form logical and/or relational connections between the input data 102 and the previously stored data to facilitate further verification of the input data 102. In an embodiment, if all input data 102 is not linked to previously stored data, the user may be notified accordingly. In an embodiment, the synchronous verification 144 may also include verifying typographical information for the input data 102. Such verification may include checking the input data 102 for spelling errors, incorrect identifying information (e.g., account numbers for a customer or business organization may be of an expected length or format), and/or incomplete information (e.g., data fields for the input data 102 may be missing or not fully entered).

Following the synchronous verification 144, asynchronous verification tasks 146 may be performed on the input data 102. In an embodiment, the asynchronous verification tasks 146 may be performed in an offline manner by the networked server 120, which may free up processing resources of the client terminal 110 for further processing tasks, data verification or otherwise. In various embodiments, the asynchronous data verification may include comparing the input data 102 with the previously stored system data to verify the content of the input data 102. As noted above, in an invoice reporting system, this may include verifying purchase order information with invoice and work product information that may be entered into the system 100 (i.e., the input data 102). Following the asynchronous verification 146 for the input data 102, a report may be compiled to indicate results of the asynchronous verification. In an embodiment, the results may be communicated to the user. If applicable, the asynchronous verification may then proceed to verify a subsequent set of input data (not shown) entered into the system 100.

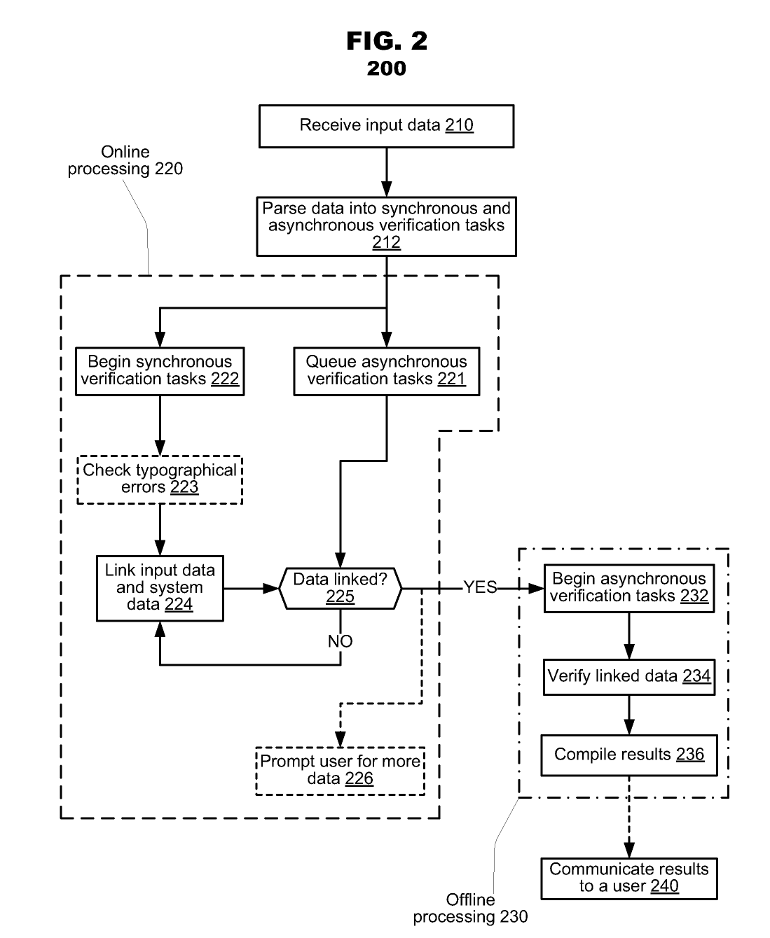

FIG. 2 illustrates a flow diagram of a method 200 to provide for asynchronous data verification according to an embodiment of the present invention. As illustrated in FIG. 2, the method 200 may receive input data (block 210). In an embodiment, the input data may be entered by a user. In another embodiment, the input data may be entered electronically, e.g., uploaded in an electronic format. At block 212, the method 200 may parse the input data into synchronous data verification tasks and asynchronous data verification tasks.

The method 200 may perform the synchronous data verification tasks in online processing manner (box 220), as data may be input to the system. The method 200 may perform the asynchronous data verification tasks in an offline manner (box 230), following the various synchronous processing tasks.

At block 221, the method 200 may queue the asynchronous data verification tasks. At block 222, the method may begin the synchronous data verification tasks. In an embodiment, the synchronous data verification may include checking the input data for typographical errors (block 223). At block 224, the method 200 may link the input data with data stored in a system. For example, the linking may include forming logical connections between purchase orders and invoices and accompanying work product information for an invoice reporting system.

At block 225, the method may check if all input data has been linked accordingly. If not, the method may continue linking the data (return to block 224). If all the input data has been linked, the method 200 may begin asynchronous data verification tasks at block 232. The asynchronous data verification tasks may include verifying the input data with data stored in the system (block 234). Following the asynchronous data verification, the method 200 may compile the data verification results in a report (block 236). In an embodiment, the results may be communicated to a user (block 240).

In an embodiment, the method 200 may prompt the user to input more data following the data linking that may be performed in an asynchronous manner (block 226). As noted above, one advantage of an asynchronous data verification system is that asynchronous data verification may be performed in an offline manner. Following synchronous verification for a first set of input data, a second set of data may be input to the system. Asynchronous data verification for the two data sets may be queued as described at block 221 and processed accordingly, with the results communicated to a user upon completion.

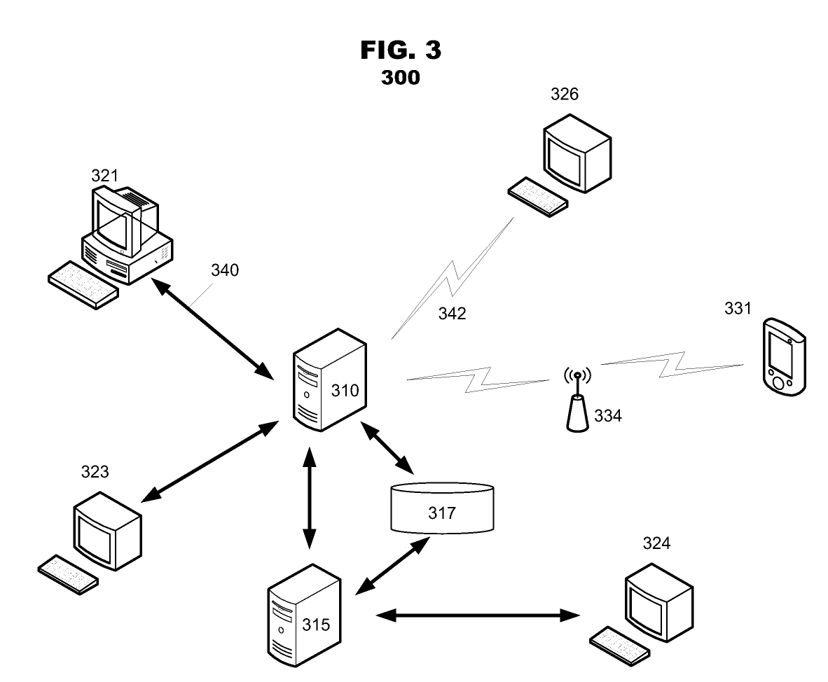

FIG. 3 illustrates an exemplary hardware configuration for implementing a system 300 according to an embodiment of the present invention. The system 300 may comprise one or more networked servers 310 and 315, one or more client terminals 321, 323, 324 and 326, data storage devices 317, wired and wireless communication links 340 and 342, wireless access point 334, and a portable device(s) 331. The one or more networked servers 310 and 315 may execute a multi-application software system. The servers 310 and 315 may include processor(s), internal memory and related computer program instructions (all not shown).

The server 310 and/or 315 may execute computer instructions for an enterprise software system that facilitates provision of asynchronous data verification. The server 310 may access data storage device(s) 317 that store machine-readable software instructions that may be accessed and executed by the processor(s) of the server 310.

The data storage device(s) 317 also may store data related to the operation of an enterprise including purchase order information, invoice information, accounting data, and work product information. The data storage device 317 that may be a hard disk drive, non-volatile memory, flash memory, or any suitable device for storing electronic data, and may be organized as a object-oriented or relational database. The data storage may maintain hierarchical data structures containing information related to a variety of different business functions of an enterprise. For example, in an accounting environment, invoicing, accounts due, accounts payable, projected revenue and the like may be maintained.

The servers 310 and 315 may communicate with client terminal(s) 321, 323, 324, 326 and portable device(s) 331 via network connections 340 and 342. The client terminals 321, 323, 324 and 326 may include a processor, display device, and data storage device, such as a hard disk (all not shown). The client terminals 321, 323, 324 and 326, and the portable device 331 may receive user input data and participate in execution of program instructions for business applications and/or business application UIs. The portable device 331 may be a smartphone, personal digital assistant, tablet, notebook or mini-notebook computer capable of wired and/or wireless communication. The portable device 331 may include memory, a processor, input device, display, and devices that enable wired or wireless communication.

The number of servers, number of clients and topology of the network connections between them are immaterial to the present discussion unless otherwise noted.

The exemplary method and computer program instructions may be embodied on a machine readable storage medium such as a computer disc, optically-readable media, magnetic media, hard drives, RAID storage device, and flash memory. In addition, a server or a database server may include machine readable media configured to store machine executable program instructions. The features of the disclosed embodiments may be implemented in hardware, software, firmware, or a combination thereof and utilized in systems, subsystems, components or subcomponents thereof. When implemented in software, the elements of the disclosed embodiments are programs or the code segments used to perform the necessary tasks. The program or code segments can be stored on machine readable storage media. The “machine readable storage media” may include any medium that can store information. Examples of a machine readable storage medium may include electronic circuits, semiconductor memory device, ROM, flash memory, erasable ROM (EROM), floppy diskette, CD-ROM, optical disk, hard disk, fiber optic medium, any electromagnetic storage device, or optical. The code segments may be downloaded via computer networks such as Internet, Intranet, etc. The disclosed embodiments may be used in a semantic business application solution to support context-related search in SAP business applications (e.g., SAP ERP, SAP CRM, etc.) and/or non-SAP systems. The business knowledge provided by a semantic network can be used by all business applications, e.g. as a semantic extension.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the sprit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

We claim:

1. A computer system, comprising:
a processor, responsive to data input, configured to:
parse the input data into synchronous data verification tasks and asynchronous data verification tasks;
queue the asynchronous data verification tasks;
verify the input data through the synchronous data verification tasks, wherein the synchronous data verification tasks include linking the input data to data stored in the data verification system;
when the input data is linked to the data stored in the data verification system, verify the input data through the asynchronous data verification tasks,
wherein the asynchronous data verification tasks include comparing the input data to the data stored in the data verification system; and
when the asynchronous data verification tasks are complete, compiling a report to indicate result of the asynchronous data verification tasks.

2. The computer system of claim 1, wherein the processor is further configured to:
notify a user when any of the input data fails to be linked to the data stored in the data verification system fails.

3. The computer system of claim 1, wherein the synchronous data verification tasks include includes verifying typographical information for the input data.

4. The computer system of claim 3, wherein the verifying typographical information includes checking the input data for spelling errors, incorrect identifying information, and/or incomplete information.

5. The computer system of claim 1, wherein the asynchronous data verification tasks are performed in an offline manner.

6. The computer system of claim 1, wherein the input data is uploaded in an electronic format.

7. The computer system of claim 1, wherein the asynchronous data verification tasks include verify purchase order information with invoice and work product information.

8. A method, comprising:
receiving input data;
parsing the input data into synchronous data verification tasks and asynchronous data verification tasks;
queuing the asynchronous data verification tasks;
verifying the input data through the synchronous data verification tasks, wherein the synchronous data verification tasks include linking the input data to data stored in the data verification system;
when the input data is linked to the data stored in the data verification system, verify the input data through the asynchronous data verification tasks, wherein the asynchronous data verification tasks include comparing the input data to the data stored in the data verification system; and
when the asynchronous data verification tasks are complete, compiling a report to indicate result of the asynchronous data verification tasks.

9. The method of claim 8, wherein the processor is further configured to:
notify a user when any of the input data fails to be linked to the data stored in the data verification system fails.

10. The method of claim 8, wherein the synchronous data verification tasks include includes verifying typographical information for the input data.

11. The method of claim 10, wherein the verifying typographical information includes checking the input data for spelling errors, incorrect identifying information, and/or incomplete information.

12. The method of claim 8, wherein the asynchronous data verification tasks are performed in an offline manner.

13. The method of claim 8, wherein the input data is uploaded in an electronic format.

14. The method of claim 8, wherein the asynchronous data verification tasks include verify purchase order information with invoice and work product information.

15. A non-transitory computer readable medium storing a program causing a computer to execute a process, the process comprising:
receiving input data;
parsing the input data into synchronous data verification tasks and asynchronous data verification tasks;
queuing the asynchronous data verification tasks;
verifying the input data through the synchronous data verification tasks, wherein the synchronous data verification tasks include linking the input data to data stored in the data verification system;
when the input data is linked to the data stored in the data verification system, verify the input data through the asynchronous data verification tasks, wherein the asynchronous data verification tasks include comparing the input data to the data stored in the data verification system; and
when the asynchronous data verification tasks are complete, compiling a report to indicate result of the asynchronous data verification tasks.

16. The non-transitory computer readable medium of claim 15, wherein the processor is further configured to:
notify a user when any of the input data fails to be linked to the data stored in the data verification system fails.

17. The non-transitory computer readable medium of claim 15, wherein the synchronous data verification tasks include checking the input data for spelling errors, incorrect identifying information, and/or incomplete information.

18. The non-transitory computer readable medium of claim 15, wherein the asynchronous data verification tasks are performed in an offline manner.

19. The non-transitory computer readable medium of claim 15, wherein the input data is uploaded in an electronic format.

20. The non-transitory computer readable medium of claim 15, wherein the asynchronous data verification tasks include verify purchase order information with invoice and work product information.
